(19) United States
(12) Patent Application Publication
(10) Pub. No.: US 2015/0193971 A1
(43) Pub. Date: Jul. 9, 2015

(54) Methods and Systems for Generating a Map including Sparse and Dense Mapping Information

(71) Applicant: Motorola Mobility LLC, Sunnyvale, CA (US)

(72) Inventors: Ivan Dryanovski, Sunnyvale, CA (US); Simon Lynen, Sunnyvale, CA (US); Joel Hesch, Sunnyvale, CA (US)

(73) Assignee: Motorola Mobility LLC, Sunnyvale, CA (US)

(21) Appl. No.: 14/146,808

(22) Filed: Jan. 3, 2014

(51) Int. Cl. G06T 17/05

(52) U.S. Cl. CPC G06T 17/05; G06T 2207/10004; G06T 2207/30232; G06T 2207/10028

(57) ABSTRACT

Methods and systems for map generation are described. A computing device may receive outputs from a plurality of sensors at a position of the device in an environment, which may include data corresponding to visual features of the environment at the first position. Based on correspondence in the outputs from the plurality of sensors, the computing device may generate a map of the environment comprising sparse mapping data, and the sparse mapping data comprises the data corresponding to the visual features. The device may receive additional outputs at other positions of the device in the environment and may modify the map based on the additional outputs. In addition, the device may modify the map based on receiving dense mapping information from sensors, which may include data corresponding to objects in the environment in a manner such that represents a structure of the object in the environment.

### BACKGROUND

Unless otherwise indicated herein, the materials described in this section are not prior art to the claims in this application and are not admitted to be prior art by inclusion in this section.

A map may exist as a visual representation of an area, which may highlight relationships between elements of that space such as objects, regions, and themes. Typically, a map may present information in a static two-dimensional (2D) format, which may be a geometrically accurate representation of a three-dimensional (3D) space. A map may be configured to illustrate a room, a building, a neighborhood, etc. Similarly, a map may also range in the amount of information encompassed within the map as well.

### SUMMARY

The present application discloses embodiments that relate to methods and systems for generating a map including sparse and dense mapping information.

In one aspect, an example method is described, which may be performed by a device configured with a plurality of sensors. The method may include receiving one or more outputs of the plurality of sensors at a first position of the device in an environment, and the one or more outputs comprise a first set of data corresponding to one or more visual features of the environment associated with the first position. The method may further include generating, based on correspondence in the one or more outputs of the plurality of sensors, a map of the environment comprising sparse mapping data indicative of the first set of data. The method may also include receiving one or more additional outputs of the plurality of sensors at a second position of the device in the environment, and the one or more additional outputs comprise a second set of data corresponding to one or more visual features of the environment associated with the second position. The method may further comprise modifying the map of the environment to further comprise sparse mapping data indicative of the second set of data. The method may additionally include receiving dense mapping information via one or more of the plurality of sensors, and the dense mapping information comprises data corresponding to objects in the environment in a manner representative of a relative structure of the objects in the environment. The method may also include modifying the map of the environment to comprise the dense mapping information.

In another aspect, a non-transitory computer readable storage medium having stored therein instructions, that when executed by a computing device, cause the computing device to perform functions. The functions may include receiving one or more outputs of the plurality of sensors at a first position of the device in an environment, and the one or more outputs comprise a first set of data corresponding to one or more visual features of the environment associated with the first position. The functions may further include generating, based on correspondence in the one or more outputs of the plurality of sensors, a map of the environment comprising sparse mapping data indicative of the first set of data. The functions may also include receiving one or more additional outputs of the plurality of sensors at a second position of the device in the environment, and the one or more additional outputs comprise a second set of data corresponding to one or more visual features of the environment associated with the second position. The functions may further comprise modifying the map of the environment to further comprise sparse mapping data indicative of the second set of data. The functions may additionally include receiving dense mapping information via one or more of the plurality of sensors, and the dense mapping information comprises data corresponding to objects in the environment in a manner representative of a relative structure of the objects in the environment. The functions may also include modifying the map of the environment to comprise the dense mapping information.

In a further aspect, a system is provided that comprises at least one processor, a plurality of sensors, and a memory having stored thereon instructions that, upon execution by the at least one processor, cause the system to perform functions. The functions may include receiving one or more outputs of the plurality of sensors at a first position of the device in an environment, and the one or more outputs comprise a first set of data corresponding to one or more visual features of the environment associated with the first position. The functions may further include generating, based on correspondence in the one or more outputs of the plurality of sensors, a map of the environment comprising sparse mapping data indicative of the first set of data. The functions may also include receiving one or more additional outputs of the plurality of sensors at a second position of the device in the environment, and the one or more additional outputs comprise a second set of data corresponding to one or more visual features of the environment associated with the second position. The functions may further comprise modifying the map of the environment to further comprise sparse mapping data indicative of the second set of data. The functions may additionally include receiving dense mapping information via one or more of the plurality of sensors, and the dense mapping information comprises data corresponding to objects in the environment in a manner representative of a relative structure of the objects in the environment. The functions may also include modifying the map of the environment to comprise the dense mapping information.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram depicting an example computing device.

FIG. 2 illustrates another in accordance with an example embodiment.

FIGS. 3A-3B illustrate an example computing device.

FIG. 4 is a flow chart of an example method for generating a map.

FIG. 5 is a conceptual illustration of an example computing device displaying an example map.

FIG. 6 is a conceptual illustration of an example computing device displaying another example map.

FIG. 7 is another conceptual illustration of an example computing device displaying another example map.

FIG. 8 is a conceptual illustration of an example cloud network in communication with example computing devices.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

Within examples, a computing device, such as a mobile device, may include a plurality of sensors configured to capture information corresponding to the device's environment. Based on the environment information captured by the sensors, the computing device may be configured to develop a map of the environment. In particular, the computing device may generate the map utilizing various methods and/or systems, which may include generating a map to encompass a sparse mapping based on basic visual features in the environment and modifying the generated map with sparse mapping to further include dense mapping information that provides data corresponding to the structure and/or other parameters of objects in the environment. The computing device may modify the map based on the outputs of sensors meeting a correspondence threshold, which may include using feature matching analysis and/or other correspondence measuring methods.

In one example implementation, a computing device may perform a method that may include receiving outputs of the sensors based on a first or initial position of the device in the environment. The received outputs may provide data corresponding to visual features of the environment at the first position. Visual features may be distinct features of the environment that the sensors of the computing device may be able to track as the computing device changes position and/or orientation. For example, the sensors may detect and track corners of walls/buildings, edges of objects, and other distinct features within the environment.

Based on correspondence in the outputs of multiple sensors, the computing device may generate a sparse mapping that may include the data obtained from the visual features of the environment at the first position. The computing device may be configured to determine a correspondence between the outputs in sensors to ensure the accuracy of the information captured (e.g., verify that sensors are calibrated). Likewise, the computing device may use different types of correspondence between sensors to determine if the computing device should use the outputs of the sensors. For example, the computing device may use some format of feature matching to determine if the outputs of multiple sensors provide information relating to the same features in the environment.

In addition, the computing device may also use varying degrees of thresholds associated with determining correspondence between the outputs of sensors. For example, the computing device may require a threshold amount regarding the feature matching within images captured by sensors. Likewise, the computing device may use feature tracking associated with computer vision techniques to determine matches above a predefined threshold, which may vary within examples. The computing device may be configured to require different thresholds of correspondence based on the type of thresholds and/or how recent the various sensors may have been calibrated, for example.

In order to further develop the sparse mapping to encompass more information, the device may receive additional sensor outputs when the device is located at a second position in the environment. In particular, the sensors may capture new information when the device is located at a new position, which may vary slightly from the first position or may be a larger variation, for example. Likewise, the sensors may capture new information at a second position that may be the same as the first position. In some instances, the computing device may receive sensor outputs continuously as the device changes position and/or orientation within the environment.

The additional sensor outputs may provide the computing device with data corresponding to visual features of the environment at the second position. In some instances, the device may capture the same visual features in the second position as the first position (e.g., if the device slightly moves between positions). As a result, tracking visual features within the environment may enable a computing device to determine its location, which may also contribute to developing the computing device's sparse mapping data. For example, the device may modify the sparse mapping data to include the data corresponding to visual features in the second position. In the case that the visual features possibly overlap, the computing device may aggregate the data to develop its map or may filter the data in other ways, such as selecting the information more recently received to include within the map.

In addition, the computing device may further develop the sparse mapping through configuring the sparse mapping to include dense mapping information. To illustrate, the computing device may receive dense mapping information from sensors, such as depth cameras and a structured light unit, for example. The dense mapping information may include data that captures and represents structure of objects in the environment. The dense mapping may capture details about objects in the environment that the sparse mapping may not include, for example. The computing device may modify its map (e.g., sparse mapping) to include the dense mapping information.

In an example implementation, a computing device may develop multiple representations of a 3D environment, which may be configured into a map format. In particular, the computing device may develop a first level made up of sparse mapping data, which may be captured by device sensors as the computing device moves. The first level that includes sparse mapping data may exist as a framework of data points, but may not be recognizable as corresponding to room and/or objects. Rather, the sparse mapping data may provide data points corresponding to estimates of visual features tracked in the environment as the computing device changes position.

In addition, within the example implementation, the computing device may develop an additional layer to configure with the first level made up of sparse mapping data. The additional layer may include data points that provide a dense representation of the environment. For example, a primary source of dense representation may correspond to depth data, which may be captured by the computing device by using a structured light sensor. For instance, the computing device may capture depth data through using a depth camera, which may provide depth images to the computing device. The computing device may reconstruct 3D geometry of the environment captured in the depth images using reconstruction software and/or processes.

Further, the computing device may further use estimated trajectory information to configure 3D segments of environments into a global object, which may exist in map format, for example. Particularly, the computing device may change positions to capture various segments of environments using sensors and may configure the various segments into a global map. In some instances, the computing device may be configured to determine whether depth data received from sensors is indicative of unwanted noise. The computing device may remove depth data that corresponds to noise. Likewise, the computing device may also aggregate multiple depth images from various orientations and/or positions to reduce the amount of depth data used that corresponds to noise.

In a further aspect, the computing device may send and/or receive map data with other devices and/or servers (e.g., cloud network). Within examples, the computing device may provide or receive sparse mapping information, dense mapping information, and/or a combination to other entities. In particular, the computing device may receive map data that may correspond to environments that the computing device has not actually captured map data within. The cloud network and/or other devices may provide new map data that may be used by the computing device to modify and/or update its map. In such an example, the computing device may be capable of determining its location using map data despite may not have visited the particular environment previously. To determine its location, the computing device may use various techniques and/or data, such as outputs from sensors and/or the generated map.

As previously indicated, a cloud (e.g., server) may receive map data from devices, which the cloud may store in memory for access by the computing device. In an example implementation, the cloud may aggregate map data from multiple devices to create and update a major map or multiple maps, which the cloud may share with computing devices. The cloud's map may include information provided from any number of devices and may be continuously updated through receiving new map data from devices.

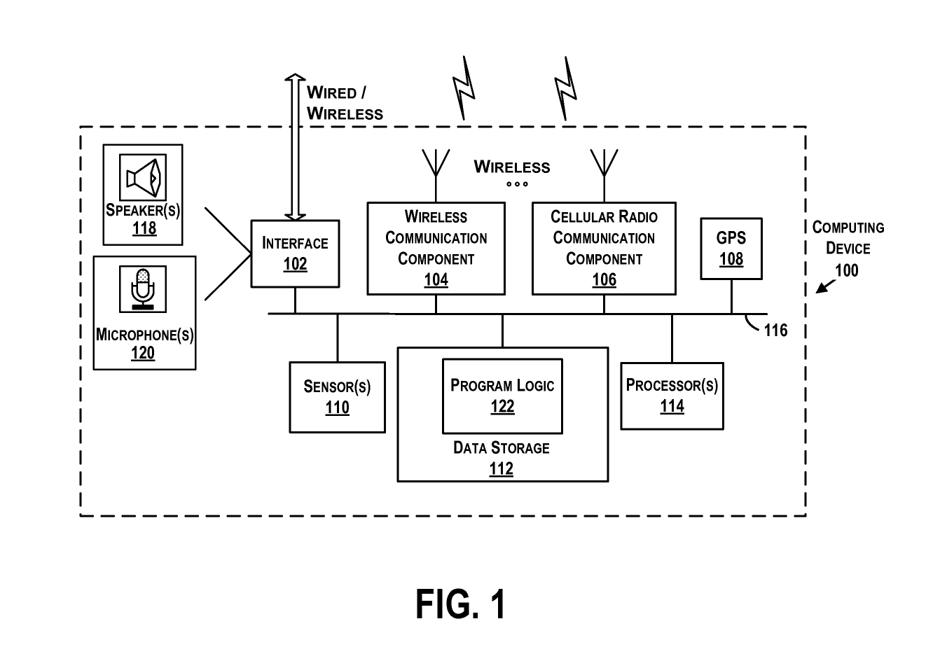

Referring now to the figures, FIG. 1 illustrates an example computing device 100. In some examples, components illustrated in FIG. 1 may be distributed across multiple computing devices. However, for the sake of example, the components are shown and described as part of one example computing device 100. The computing device 100 may be or include a mobile device (such as a mobile phone), desktop computer, laptop computer, email/messaging device, tablet computer, or similar device that may be configured to perform the functions described herein. Generally, the computing device 100 may be any type of computing device or transmitter that is configured to transmit data or receive data in accordance with methods and functions described herein.

The computing device 100 may include an interface 102, a wireless communication component 104, a cellular radio communication component 106, a global position system (GPS) receiver 108, sensor(s) 110, data storage 112, and processor(s) 114. Components illustrated in FIG. 1 may be linked together by a communication link 116. The computing device 100 may also include hardware to enable communication within the computing device 100 and between the computing device 100 and other computing devices (not shown), such as a server entity. The hardware may include transmitters, receivers, and antennas, for example.

The interface 102 may be configured to allow the computing device 100 to communicate with other computing devices (not shown), such as a server. Thus, the interface 102 may be configured to receive input data from one or more computing devices, and may also be configured to send output data to the one or more computing devices. The interface 102 may be configured to function according to a wired or wireless communication protocol. In some examples, the interface 102 may include buttons, a keyboard, a touchscreen, speaker(s) 118, microphone(s) 120, and/or any other elements for receiving inputs, as well as one or more displays, and/or any other elements for communicating outputs.

The wireless communication component 104 may be a communication interface that is configured to facilitate wireless data communication for the computing device 100 according to one or more wireless communication standards. For example, the wireless communication component 104 may include a Wi-Fi communication component that is configured to facilitate wireless data communication according to one or more IEEE 802.11 standards. As another example, the wireless communication component 104 may include a Bluetooth communication component that is configured to facilitate wireless data communication according to one or more Bluetooth standards. Other examples are also possible.

The cellular radio communication component 106 may be a communication interface that is configured to facilitate wireless communication (voice and/or data) with a cellular wireless base station to provide mobile connectivity to a network. The cellular radio communication component 106 may be configured to connect to a base station of a cell in which the computing device 100 is located, for example.

The GPS receiver 108 may be configured to estimate a location of the computing device 100 by precisely timing signals sent by GPS satellites.

The sensor(s) 110 may include one or more sensors, or may represent one or more sensors included within the computing device 100. Example sensors include an accelerometer, gyroscope, pedometer, light sensors, microphone, camera(s), infrared flash, barometer, magnetometer, GPS, Wi-Fi, near field communication (NFC), Bluetooth, projector, depth sensor, temperature sensors, or other location and/or context-aware sensors.

The data storage 112 may store program logic 122 that can be accessed and executed by the processor(s) 114. The data storage 112 may also store data collected by the sensor(s) 110, or data collected by any of the wireless communication component 104, the cellular radio communication component 106, and the GPS receiver 108.

The processor(s) 114 may be configured to receive data collected by any of sensor(s) 110 and perform any number of functions based on the data. As an example, the processor(s) 114 may be configured to determine one or more geographical location estimates of the computing device 100 using one or more location-determination components, such as the wireless communication component 104, the cellular radio communication component 106, or the GPS receiver 108. The processor(s) 114 may use a location-determination algorithm to determine a location of the computing device 100 based on a presence and/or location of one or more known wireless access points within a wireless range of the computing device 100. In one example, the wireless location component 104 may determine the identity of one or more wireless access points (e.g., a MAC address) and measure an intensity of signals received (e.g., received signal strength indication) from each of the one or more wireless access points. The received signal strength indication (RSSI) from each unique wireless access point may be used to determine a distance from each wireless access point. The distances may then be compared to a database that stores information regarding where each unique wireless access point is located. Based on the distance from each wireless access point, and the known location of each of the wireless access points, a location estimate of the computing device 100 may be determined.

In another instance, the processor(s) 114 may use a location-determination algorithm to determine a location of the computing device 100 based on nearby cellular base stations. For example, the cellular radio communication component 106 may be configured to identify a cell from which the computing device 100 is receiving, or last received, signal from a cellular network. The cellular radio communication component 106 may also be configured to measure a round trip time (RTT) to a base station providing the signal, and combine this information with the identified cell to determine a location estimate. In another example, the cellular communication component 106 may be configured to use observed time difference of arrival (OTDOA) from three or more base stations to estimate the location of the computing device 100.

In some implementations, the computing device 100 may include a device platform (not shown), which may be configured as a multi-layered Linux platform. The device platform may include different applications and an application framework, as well as various kernels, libraries, and runtime entities. In other examples, other formats or operating systems may operate the computing g device 100 as well.

The communication link 116 is illustrated as a wired connection; however, wireless connections may also be used. For example, the communication link 116 may be a wired serial bus such as a universal serial bus or a parallel bus, or a wireless connection using, e.g., short-range wireless radio technology, or communication protocols described in IEEE 802.11 (including any IEEE 802.11 revisions), among other possibilities.

The computing device 100 may include more or fewer components. Further, example methods described herein may be performed individually by components of the computing device 100, or in combination by one or all of the components of the computing device 100.

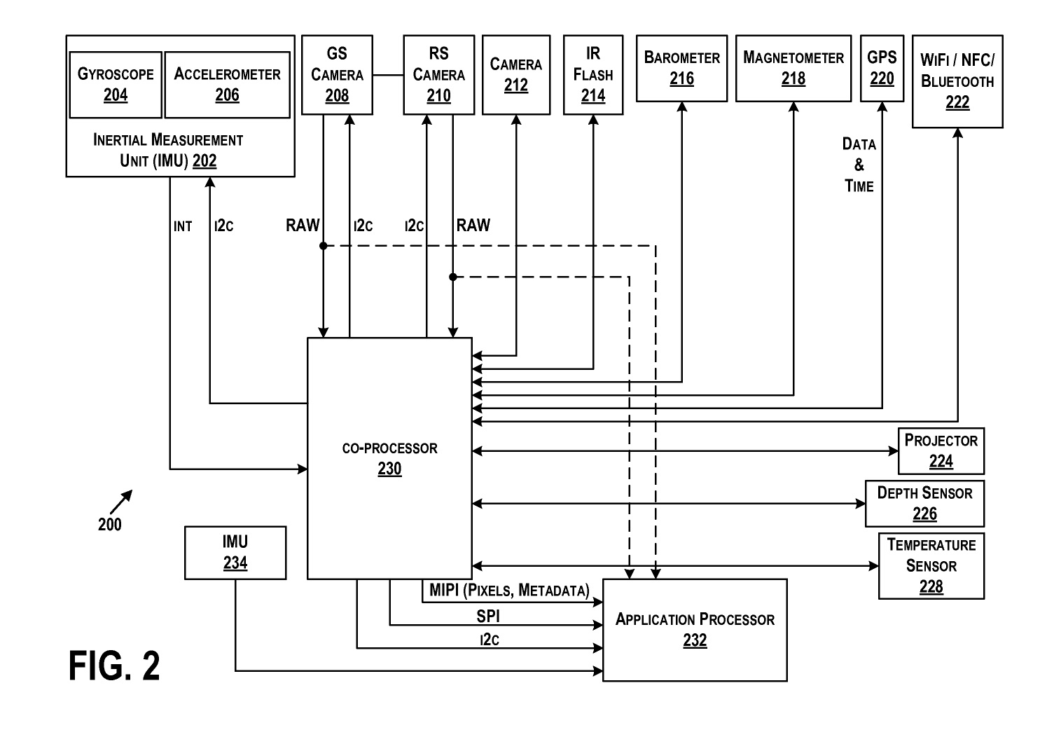

FIG. 2 illustrates another example computing device 200. The computing device 200 in FIG. 2 may be representative of a portion of the computing device 100 shown in FIG. 1. In FIG. 2, the computing device 200 is shown to include a number of sensors such as an inertial measurement unit (IMU) 202 including a gyroscope 204 and an accelerometer 206, a global shutter (GS) camera 208, a rolling shutter (RS) camera 210, a front facing camera 212, an infrared (IR) flash 214, a barometer 216, a magnetometer 218, a GPS receiver 220, a WiFi/NFC/Bluetooth sensor 222, a projector 224, a depth sensor 226, and a temperature sensor 228, each of which outputs to a co-processor 230. The co-processor 230 receives input from and outputs to an application processor 232. The computing device 200 may further include a second IMU 234 that outputs directly to the application processor 232.

The IMU 202 may be configured to determine a velocity, orientation, and gravitational forces of the computing device 200 based on outputs of the gyroscope 204 and the accelerometer 206.

The GS camera 208 may be configured on the computing device 200 to be a rear facing camera, so as to face away from a front of the computing device 200. The GS camera 208 may be configured to read outputs of all pixels of the camera 208 simultaneously. The GS camera 208 may be configured to have about a 120-170 degree field of view, such as a fish eye sensor, for wide-angle viewing.

The RS camera 210 may be configured to read outputs of pixels from a top of the pixel display to a bottom of the pixel display. As one example, the RS camera 210 may be a red/green/blue (RGB) infrared (IR) 4 megapixel image sensor, although other sensors are possible as well. The RS camera 210 may have a fast exposure so as to operate with a minimum readout time of about 5.5 ms, for example. Like the GS camera 208, the RS camera 210 may be a rear facing camera.

The camera 212 may be an additional camera in the computing device 200 that is configured as a front facing camera, or in a direction facing opposite of the GS camera 208 and the RS camera 210. The camera 212 may be configured to capture images of a first viewpoint of the computing device 200 and the GS camera 208 and the RS camera 210 may be configured to capture images of a second viewpoint of the device that is opposite the first viewpoint. The camera 212 may be a wide angle camera, and may have about a 120-170 degree field of view for wide angle viewing, for example.

The IR flash 214 may provide a light source for the computing device 200, and may be configured to output light in a direction toward a rear of the computing device 200 so as to provide light for the GS camera 208 and RS camera 210, for example. In some examples, the IR flash 214 may be configured to flash at a low duty cycle, such as 5 Hz, or in a non-continuous manner as directed by the co-processor 230 or application processor 232. The IR flash 214 may include an LED light source configured for use in mobile devices, for example.

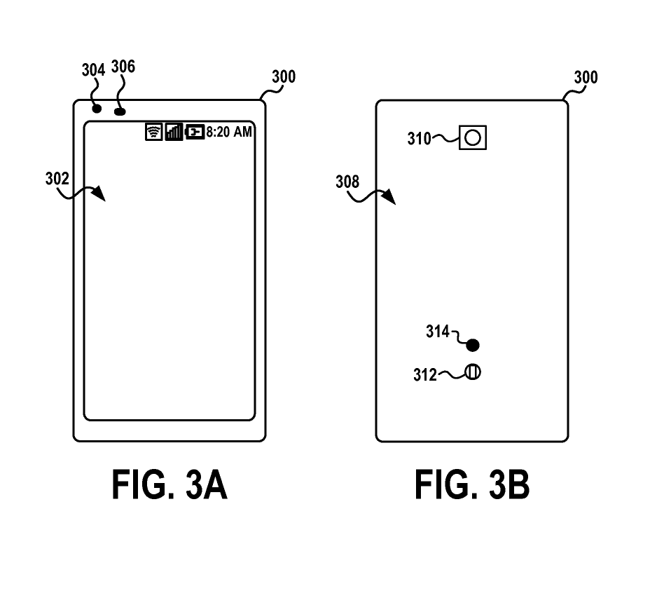

FIGS. 3A-3B are conceptual illustrations of a computing device 300 that show a configuration of some sensors of the computing device 200 in FIG. 2. In FIGS. 3A-3B, the computing device 300 is shown as a mobile phone. The computing device 300 may be similar to either of computing device 100 in FIG. 1 or computing device 200 in FIG. 2. FIG. 3A illustrates a front of the computing device 300 in which a display 302 is provided, along with a front facing camera 304, and a P/L sensor opening 306 (e.g., a proximity or light sensor). The front facing camera 304 may be the camera 212 as described in FIG. 2.

FIG. 3B illustrates a back 308 of the computing device 300 in which a rear camera 310 and another rear camera 314 are provided. The rear camera 310 may be the RS camera 210 and the rear camera 312 may be the GS camera 208, as described in the computing device 200 in FIG. 2. The back 308 of the computing device 300 also includes an IR-flash 314, which may be the IR flash 214 or the projector 224 as described in the computing device 200 in FIG. 2. In one example, the IR flash 214 and the projector 224 may be one in the same. For instance, a single IR flash may be used to perform the functions of the IR flash 214 and the projector 224. In another example, the computing device 300 may include a second flash (e.g., an LED flash) located near the rear camera 310 (not shown). A configuration and placement of the sensors may be helpful to provide desired functionality of the computing device 300, for example, however other configurations are possible as well.

Referring back to FIG. 2, the barometer 216 may include a pressure sensor, and may be configured to determine air pressures and altitude changes.

The magnetometer 218 may be configured to provide roll, yaw, and pitch measurements of the computing device 200, and can be configured to operate as an internal compass, for example. In some examples, the magnetometer 218 may be a component of the IMU 202 (not shown).

The GPS receiver 220 may be similar to the GPS receiver 108 described in the computing device 100 of FIG. 1. In further examples, the GPS 220 may also output timing signals as received from GPS satellites or other network entities. Such timing signals may be used to synchronize collected data from sensors across multiple devices that include the same satellite timestamps.

The WiFi/NFC/Bluetooth sensor 222 may include wireless communication components configured to operate according to WiFi and Bluetooth standards, as discussed above with the computing device 100 of FIG. 1, and according to NFC standards to establish wireless communication with another device via contact or coming into close proximity with the other device.

The projector 224 may be or include a structured light projector that has a laser with a pattern generator to produce a dot pattern in an environment. The projector 224 may be configured to operate in conjunction with the RS camera 210 to recover information regarding depth of objects in the environment, such as three-dimensional (3D) characteristics of the objects. For example, the separate depth sensor 226 may be configured to capture video data of the dot pattern in 3D under ambient light conditions to sense a range of objects in the environment. The projector 224 and/or depth sensor 226 may be configured to determine shapes of objects based on the projected dot pattern. By way of example, the depth sensor 226 may be configured to cause the projector 224 to produce a dot pattern and cause the RS camera 210 to capture an image of the dot pattern. The depth sensor 226 may then process the image of the dot pattern, use various algorithms to triangulate and extract 3D data, and output a depth image to the co-processor 230.

The temperature sensor 228 may be configured to measure a temperature or temperature gradient, such as a change in temperature, for example, of an ambient environment of the computing device 200.

The co-processor 230 may be configured to control all sensors on the computing device 200. In examples, the co-processor 230 may control exposure times of any of cameras 208, 210, and 212 to match the IR flash 214, control the projector 224 pulse sync, duration, and intensity, and in general, control data capture or collection times of the sensors. The co-processor 230 may also be configured to process data from any of the sensors into an appropriate format for the application processor 232. In some examples, the co-processor 230 merges all data from any of the sensors that corresponds to a same timestamp or data collection time (or time period) into a single data structure to be provided to the application processor 232.

The application processor 232 may be configured to control other functionality of the computing device 200, such as to control the computing device 200 to operate according to an operating system or any number of software applications stored on the computing device 200. The application processor 232 may use the data collected by the sensors and received from the co-processor to perform any number of types of functionality. The application processor 232 may receive outputs of the co-processor 230, and in some examples, the application processor 232 may receive raw data outputs from other sensors as well, including the GS camera 208 and the RS camera 210.

The second IMU 234 may output collected data directly to the application processor 232, which may be received by the application processor 232 and used to trigger other sensors to begin collecting data. As an example, outputs of the second IMU 234 may be indicative of motion of the computing device 200, and when the computing device 200 is in motion, it may be desired to collect image data, GPS data, etc. Thus, the application processor 232 can trigger other sensors through communication signaling on common buses to collect data at the times at which the outputs of the IMU 234 indicate motion.

The computing device 200 shown in FIG. 2 may include a number of communication buses between each of the sensors and processors. For example, the co-processor 230 may communicate with each of the IMU 202, the GS camera 208, and the RS camera 212 over an inter-integrated circuit (I2C) bus that includes a multi-master serial single-ended bus for communication. The co-processor 230 may receive raw data collected, measured, or detected by each of the IMU 202, the GS camera 208, and the RS camera 212 over the same I2C bus or a separate communication bus. The co-processor 230 may communicate with the application processor 232 over a number of communication buses including a serial peripheral interface (SPI) bus that includes a synchronous serial data link that may operate in full duplex mode, the I2C bus, and a mobile industry processor interface (MIPI) that includes a serial interface configured for communicating camera or pixel information. Use of various buses may be determined based on need of speed of communication of data as well as bandwidth provided by the respective communication bus, for example.

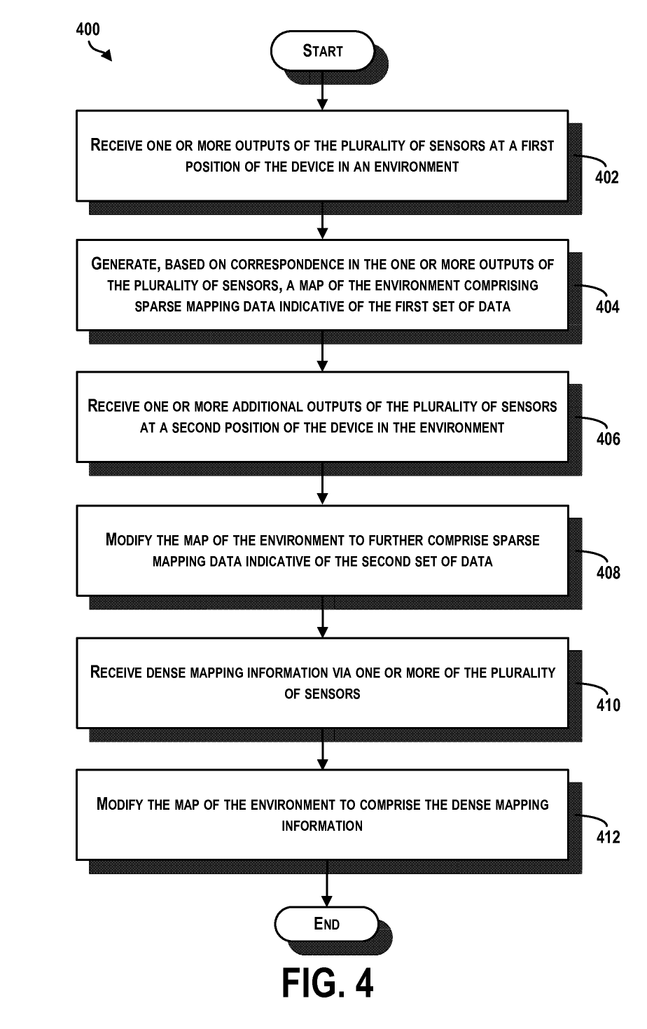

FIG. 4 is a flow chart of a method 400 for generating a map using information provided by sensors. Other example methods for generating a map using information provided by sensors may exist as well.

The method 400 may include one or more operations, functions, or actions as illustrated by one or more of blocks 402-412. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 400 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

Furthermore, for the method 400 and other processes and methods disclosed herein, each block in FIG. 4 may represent circuitry that is wired to perform the specific logical functions in the process.

At block 402, the method 400 may include receiving one or more outputs of the plurality of sensors at a first position of the device in an environment. In particular, a computing device may receive sensor outputs that provide a first set of data corresponding to visual features of the environment associated with the first position.

Within examples, any type of computing device, such as the example devices shown in FIGS. 1-2 and FIGS. 3A-3B, may be configured to receive information captured within sensor outputs, which may be provided from a variety of sensors. For example, a computing device may include system components and sensors, such as gyroscopes, accelerometers, cameras (GS/RS), barometers, magnetometers, projectors, depth sensors, temperature sensors, global positioning system (GPS), Wi-Fi sensors, near-field communication (NFC) sensors, and Bluetooth sensors, etc.

The various sensors may capture different types of information corresponding to the environment. For example, the camera system may be configured to capture images of the environment, which may include images that include depth information. The computing device's camera system may be configured to provide a large amount of information within images and may provide the information at a fast acquisition rate. Likewise, a computing device may include an IMU unit that capture measurements related to the movements of the computing device. Further, the computing device may utilize a GPS to determine the location of the computing device based on global coordinates and/or may receive other information from other devices and/or severs using a Wi-Fi sensor, a near-field communication (NFC) sensor and/or a Bluetooth sensor. In addition, the computing device may include various sensors dedicated to capturing other types of information.

During operation, the computing device may analyze the information provided by the various sensors based on the type of sensors, for example. In one such illustration of utilizing outputs from multiple types of sensors, the computing device may evaluate the images captured by the camera system along with the device's motion information as provided by the IMU unit. Combining the information provided within the images and the motion information, the computing device may determine a pose (e.g., position and orientation) of the computing device in an environment, for example. Likewise, in another example, the computing device may utilize information captured by a depth camera and a color camera to generate images that encompass both depth and the corresponding colors relating to the depth. Other examples of analyzing and using the outputs provided by device sensors may exist as well.

In addition, the computing device may be configured to associate a relative position and/or orientation of the device with information as the information may be captured by sensors. For example, the computing device may receive information relating to an environment from device sensors and associate the information with the global coordinates of the device as indicated by GPS receive at the moment of reception. Consequently, as the computing device changes position and/or orientation (e.g., the user moves the device), the sensors may continue receive to capture information about the surrounding environment and the computing device may receive the environment in a logical context that may enable the computing device to analyze the incoming information. To further illustrate, the computing device may start capturing data points corresponding to an environment after the device is initially powered on, but the computing device may recognize that the incoming data points may relate to previously received data points based on the position and/or orientation of the device in the environment, which may be based on a direction of gravity as provided by an IMU unit.

In an example implementation, the computing device may receive outputs (e.g., a first set of data) from various sensors at a first (e.g., initial) position in the environment. The sensors may receive the information in a manner that logically links (e.g., some form of correspondence) the various sensors providing information to the computing device, for instance. In contrast, in another example, the computing device may be configured to sort through the information received to determine possible links. In addition, for example purposes, the computing device receiving information at a first position may include any types of environment, including but not limited to, outdoor environments, inside buildings, inside vehicles, and other places, etc. As a general matter, as long as the device may access the environment, the device sensors may be configured to capture information corresponding to the environment.

To further illustrate, the sensor outputs may provide the computing device with measurements relating to objects within the environment at the first position, for example. For example, the computing device may receive outputs that provide information corresponding to visual features in the environment. The visual features may represent distinct features within the environment, such as corners or other portions of objects or buildings, etc., that sensors may quickly and efficiently capture information about.

In some aspects, the sensors may capture information corresponding to visual features in the environment during a first analysis of the environment by the sensors. The sensors may acquire data points corresponding to the more distinct features of the environment (e.g., visual features) prior to capturing data points corresponding to smaller, less distinctive features in the same environment. The few data points corresponding to distinct features in the environment may correspond to a sparse mapping of the environment, which may encompass a basic layout of distinct features in the environment.

In addition, different device sensors may track the visual features as the computing device changes orientation and/or position (e.g., pose) within the environment. Tracking the visual features may enable a computing device to determine its pose relative to features and/or other segments of an environment. Further, tracking the distinct features in the environment may include the sensors providing at least some data points to the computing device corresponding to the distinct features. As the computing device changes position or orientation in an environment, the sensors may still track the computing device's relative position and/or orientation within the environment, which may be useful for determining the location of the computing device. Tracking the orientation of the device in the environment may include determining the computing device's orientation relative to a direction of gravity. For example, the computing device may receive gravitational information from an IMU unit and utilize the gravitational information for tracking a location of the computing device. Likewise, the sensors may track the visual features to derive more information corresponding to objects and/or the environment, such as distances between objects, the computing device and objects, etc.

In one example implementation, a device may track visual features in the environment using one type of sensor and capture information using other types of sensors. Likewise, the device may utilize multiple sensors to track features and/or capture information.

At block 404, the method 400 may further include generating, based on correspondence in the one or more outputs of the plurality of sensors, a map of the environment comprising sparse mapping data indicative of the first set of data. In particular, a computing device may generate the map of the environment to include sparse mapping data that includes the first set of data captured by the sensors that corresponds to the visual features of the environment associated with the device in the first position.

Generating a map of the environment that includes sparse mapping data based on sensor outputs may include the computing device executing various map generation techniques and/or software. For example, a computing device may receive information corresponding to the 3D environment from the various sensors (e.g., cameras) and may covert the information into a 2D representation. The conversion from 3D information into a 2D map may involve the computing device utilizing projection processes and/or computer vision software, for example.

In an example implementation, the computing device may develop a map based on sparse mapping data that reflects the position and/or alignment of the distinct visual features in the environment relative to the computing device as captured by the sensors when the device initially started receiving map data at a first position. The sparse mapping data may encompass data points indicative of the visual features (e.g., distinct features of objects) within the environment as derived from the outputs of the device's sensors. In one such example, the computing device may be configured to generate a map based on sparse mapping data simultaneously as the computing device receives other types of information (e.g., dense mapping information) corresponding to the environment from the sensors. In another example, the computing device may be configured to gather and aggregate outputs from the sensors corresponding to the environment prior to generating a map using sparse mapping to reflect some of the basic aspects of the device's environment.

The computing device may be configured to generate a map based on the outputs of the sensors corresponding in some manner, which may include capturing information from the same features in the environment. Likewise, the computing device may further require the outputs of the sensors to correspond based on some threshold, which may be predefined within examples. For example, the computing device may require the outputs involve the same features beyond a predefined threshold. Other examples of correspondence, including techniques for determining correspondence between sensors, may exist as well.

In one example aspect, a computing device may generate a map of the environment using sparse mapping in a manner that establishes graphic representations of environment information for display on the device, which may include using spatial relationships as received within the sparse mapping data to represent some relationships (e.g., distances between rooms). The sparse mapping data may show relationships that may exist between objects and/or different positions of the computing device, for example.

In an example implementation, the generated map of the environment may include data corresponding to the visual features and no other features. In other implementations, the computing device may configure map to include sparse mapping that provides map data corresponding to additional elements of the environment in addition to the visual features.

In a further aspect, upon generating a map based on sparse mapping data received from sensors, the computing device may store the generated map within memory located on the device and/or remotely on a cloud (e.g., server). For example, the computing device may store the generated sparse mapping within an application, which may be closed and opened by the computing device. In addition, the device may send the sparse mapping data and/or any generated maps to other devices and/or a cloud (e.g., server) for the other entities use. Other examples of sparse mapping storage may exist as well.

At block 406, the method 400 may include receiving one or more additional outputs of the plurality of sensors at a second position of the device in the environment. To further illustrate, a computing device may receive a second set of data corresponding to visual features of the environment associated with the second position of the device. In particular, a computing device may receive additional sparse mapping data corresponding to other environments, for example.

A computing device capturing information for generating a map may change orientation and/or position while capturing environment information through sensors. In an example, the computing device may be configured to determine when the device changes position and/or orientation, which may include factoring in the direction of gravity. Further, the computing device may be configured to track any the changes in the device's pose (e.g., position and orientation) when receiving new sets of information from the sensors. The computing device may factor any changes into the reception of new information and may use the device's pose when analyzing received sensor outputs. Using the device's position and/or orientation information (e.g., IMU outputs) may further allow the computing device to organize incoming map data. The computing device may further require a correspondence in the outputs to determine whether or not sparse mapping data may be accurately reflecting the environment of the device.

In particular, as previously indicated, a computing device may receive information corresponding to a first portion of the environment and then may receive additional information from sensors that may correspond to a second or new portion of the environment. The computing device may be configured to continue to receive environment information from sensors and may use the information for map generation. For instance, the computing device may receive additional sparse mapping data at different environments.

In particular, a computing device performing the method 400 or similar methods may receive outputs from sensors as the device changes orientation and/or position in the environment. As described herein, the computing device may receive outputs from sensors at a second position after receiving outputs at an initial position. In one example, a device may receive outputs corresponding to the environment at a first position and then receive outputs from the sensors corresponding to the environment at the same position. The difference may be just a variation in time between the two gatherings of information.

As discussed, the device may include sensors that may be configured to track visual features or other points in the environment as the device changes pose relative to the environment. In an example, a device may receive outputs at a first position and then subsequently receive additional outputs at a second position. The differences between the first position and second position in the environment may vary slightly to no differences, or may vary significantly. The range of variation between the device receiving outputs from sensors may vary among different implementations.

At block 408, the method 400 may further include modifying the map of the environment to further comprise sparse mapping data indicative of the second set of data. Within examples, the computing device may continue to build and/or refine its generated map based on incoming map data as provided by the device's sensors. For example, the computing device may receive additional sparse mapping data corresponding to an environment and may modify the generated map based on the received additional sparse mapping data. For instance, modifying the generated map may include adding, removing, and/or combining map data as executed by the computing device.

In an example implementation, a computing device may receive the outputs from one or more device sensors that correspond to various environments. Within the outputs, a computing device may receive sparse mapping data, which may include data points indicative of visual features within the various environments. The computing device may receive different sparse mapping data as the device changes position and/or orientation relative to the environment. For example, the sensors of a moving computing device may receive various map data, such as sparse mapping data, corresponding to the different environments. Even slight changes in orientation and/or position of the computing device may cause the sensors to receive different map data. As the computing device receives the new map data (e.g., sparse mapping data), the computing device may modify the stored generated map based on the incoming new map data.

For instance, the computing device may receive sparse mapping data that corresponds to visual features of an environment when the device may be positioned and/or orientated at first position and may also receive sparse mapping data that corresponds to visual features of a different environment when the device may be positioned and/or orientated at a different position.

In addition, the computing device may be configured to generate a map of the multiple environments based on the different sets of sparse mapping data received. In another example, the computing device may generate multiple maps, which may occur when the environments may be distinct from each other (e.g., far away). Likewise, the computing device may modify the generated map of the environment to further include the sparse mapping data acquired by the sensors when the device may be located at a new position. The generated map may include data points corresponding to visual features from both the first environment and the new environment. This process of modifying the generated map based on incoming map data may be performed in an iterative manner by the computing. In other words, the computing device may continuously update its map to reflect incoming map data as provided by device sensors.

In another implementation, the computing device may use newly received sparse mapping data to further refine a generated map. For example, the computing device may determine within information provided by sensor outputs that the environment has changed since the last time that sparse mapping information was captured there. In such a situation, the computing device may modify the map to include some received sparse mapping data by changing the map based on previously acquired sparse mapping data to reflect the information received in the latest outputs of that environment.

During the modification of the generated map, the device may use visual features as provided by sparse mapping data. The device may track visual features in the environment and/or within the sparse mapping to determine the portions of the sparse mapping that should be updated, added, subtracted and/or refined, for example.

At block 410, the method 400 may also include receiving dense mapping information via one or more of the plurality of sensors. In particular, sensors of a computing device may capture dense mapping information that provides data corresponding to objects in the environment in a manner such that dense matter information represents a relative structure of the objects in the environment.

Similar to the sparse mapping data, a computing device may receive dense mapping information from various types of sensors. For example, a camera system that includes a GS camera and/or a RS camera may capture dense mapping information for the computing device to utilize. The different types of cameras may use a combination of captured information to assist in gathering dense mapping information.

In some examples, the sensors that capture dense mapping information may be the same sensors that capture the sparse mapping data. In other examples, different sensors may be configured to capture the dense mapping information than the sensors that capture the sparse mapping information. A computing device may be configured to determine which types of sensors capture the dense mapping information as well as the types that capture the sparse mapping data, for example.

The sensors that capture dense mapping information may be configured to capture more details of the environment. Rather than capturing map data relating to distinct visual features in the environment, a sensor may be configured to capture dense mapping information that corresponds to the structure of objects. In addition, dense mapping information may capture data points to objects that sparse mapping may not include. For example, the dense mapping information may include data points corresponding to smaller objects and/or details about the objects. The computing device may use the dense mapping information to configure a generated map to include additional information, such positions and structure of objects within the environment.

At block 412, the method 400 may include modifying the map of the environment to comprise the dense mapping information. In particular, a computing device may modify its generated map to include dense mapping information in addition to the sparse mapping. Modifying a generated map to include dense mapping information may involve the computing device performing various techniques and/or processes. For example, the computing device may update a map based on aligning visual features within the sparse mapping with the same visual features as provided within the dense mapping information.

In one aspect, the computing device may modify the generated map and/or sparse mapping to further provide structure and positions of objects within the environment based on the dense mapping information captured by the sensors for that environment. The computing device may factor additional information to modify the generated map, such as the computing device's pose and coordinates, for example.

In one example modification process, the computing device may update a map to include the dense mapping information during the generation of the map. For example, the computing device may generate a map utilizing both sparse mapping and dense mapping information simultaneously. In such an example, the computing device may receive dense mapping information from sensors as the computing device also receives the sparse mapping information. The computing device may use software to analyze the received information and to generate a map reflecting the information received.

In another example, a computing device may capture dense mapping information through using a camera capable of capturing depth images and some form of structured light. The computing device may utilize the light and camera to capture depth images, which the device may use to reconstruct 3D geometry information corresponding to the environment of the computing device as captured by the depth images. As the computing device changes positions and/or orientations, the computing device may continue to capture depth images and may use estimated trajectory factors to configure the different determined 3D geometry information together into a global format, which may exist as a map, for example.

Within the example, the computing device may also be configured to identify depth data indicative of noise. In order to reduce the amount of depth data received that may be a result of noise, the computing device may capture additional depth images, which may include capturing depth images of the same environment space from different positions and/or orientations.

In addition, in some instances, the depth images may not capture all the parts of an environment. This may occur because some textures may not be able to be measured using a camera. However, the computing device may capture the missing parts within additional depth images captured when the computing device is positioned at different positions and/or orientations, for example. Likewise, other sensors may be utilized to capture the missing information.

In some instances, the computing device may determine dense mapping information based on previously determined sparse mapping data for the same environment. In addition, the computing device may use data structures, such as occupancy data structures, that may sub-divide an environment into regular type regions, which may exist as many small boxes connected to represent the environment. For example, for each box configured by the computing device representing a small portion of the environment (e.g., 1 inch in size), the computing device may store a value of whether the box is occupied or unoccupied. The computing device may determine whether the various boxes should be filled or empty corresponding to whether an object may be located at that particular region of the environment. In one such illustration, a computing device may configure multiple boxes in a row to be filled to represent an object in the environment.

Moreover, the computing device may configure multiple observations of the same region in the environment to determine boxes that may conflict between the different observations. The computing device may use various techniques and/or software to determine whether or not boxes should be filled based on conflicting observations. For example, the computing device may determine that more observations provide that respective boxes should be empty rather than full. In that case, the computing device may be configured to go with the observations that provide the box should be empty.

In addition, the computing device may also utilize visual data captured from cameras and/or other sensors to further generate dense mapping information. For example, depth sensors associated with a computing device may generate data points that may provide objects have a round shape (e.g., generate rounded looking objects). The computing device may fuse and/or configure data from a camera to augment 3D structure for objects, which may include edge info to define objects with sharper images. The sharper images may more closely reflect the objects as the objects may appear in the environment. The computing device may use the gathered information to detect lines within images and may also detect intersection of structural planes (e.g., walls to floors) to increase the accuracy of a generated map.

A generated map representation of various environments by a computing device may provide the computing device with information regarding what spaces of the environment may be occupied or empty. Likewise, the computing device may utilize the information provided by a generated map to determine possible trajectories of the device, which may provide confidence to the computing device of areas in the environment that consist of open space and areas that may be occupied by physical structures. For example, the computing device may determine using a generated map that a certain space of the environment may be occupied by a wall and a nearby space may be an open hallway, free for the computing device to move through.

In one example implementation, a device may communicate with other devices via a wired or wireless link to send and receive sparse mapping information in between. Utilizing a network of devices, a device may receive sparse mapping corresponding to new environments, which may include environments that the device has never been present within. The network of devices may include communication securities and require passwords to enter, for example.

In another example, a device may utilize the updated generated map with sparse mapping data and/or dense mapping information to identify a location of the device relative to the environment. The computing device may analyze visual features within the environment based on sparse mapping data and/or may analyze a location based on object structure as provided by dense mapping information. In addition, the computing device may further also use information provided by the IMU unit and/or other sensors to further determine a location of the device. The information from the IMU unit may provide the computing device with position and/or orientation information for the device relative to objects in the environment and the computing device may use this information along with the generated map to determine a location of the device.

In a further example implementation, a computing device may be equipped with a camera capable of capturing depth images and another camera that may be configured to capture color images. The two cameras may operate within a camera system for the computing device, which may include the cameras being synched together to capture images corresponding to the same environment. Likewise, the camera system may include additional cameras.

Within the example implementation, the computing device may receive a depth image and a color image associated with the depth image from the camera system. The different images may be captured in a manner that results in a correspondence between the two images. In addition, the computing device may configure the any geometry captured from the depth image to be textured with the appropriate colors from the color image. In another example, the computing device may include a single camera capable of capturing both depth and color. However, the single camera may not capture depth and color at the same time, the computing device may be configured to use color information captured prior to or after the capture of a depth image to provide color to the depth image. In addition, the computing device may use other information to register color of image from some time to provide to the depth image at any time.

In another example implementation, the computing device may utilize odometry to determine pose of the computing device, which may be used without referencing against any stored data (e.g., the generated map). As the computing device observes odometry information and/or other types of information, the computing device may format the observed information into some format of a map. For example, the computing device may determine points of Wi-Fi access using device sensors and may further store the determined points of Wi-Fi access into a map format. The storage of Wi-Fi access into map format may be configured with the sparse mapping data and dense mapping information as well, for instance.

In yet another example implementation, a computing device may use sensor information to generate a map corresponding to a building. The computing device may store various information within the generated map, which may include information relating to Bluetooth, Wi-Fi, temperature, audio and/or acoustic footprints, and/or vision information, for example. In particular, vision information may correspond to points of high contrast within the environment (e.g., corners). In some implementations, vision information may be the same or similar to sparse mapping data that a computing device may acquire, and may include any number of data points corresponding to the environment. For example, a single camera associated with a computing device may collect data points corresponding to the environment and may relay the data points to various components of the computing device. The computing device may convert the captured data points into 3D data within a map, and various information may captured by the 3D data, such as features and/or information corresponding to the local environment. The computing device may add dense mapping information (e.g., depth information) to build surfaces and/or lines (e.g., walls and surfaces) based on the 3D data already captured within the map.

In addition, a computing device may use a generated map to re-localize the computing device during the next time the device may be located within the environment and/or the first time the computing device may enter the environment. The relocalization process may provide the computing device with a relative mapping of the environment (e.g, measurements relating to the positioning and orientation of the objects relative to the computing device). Furthermore, the computing device may use 3D map data to derive application behavior, which may determine routes of the computing device and/or other information.

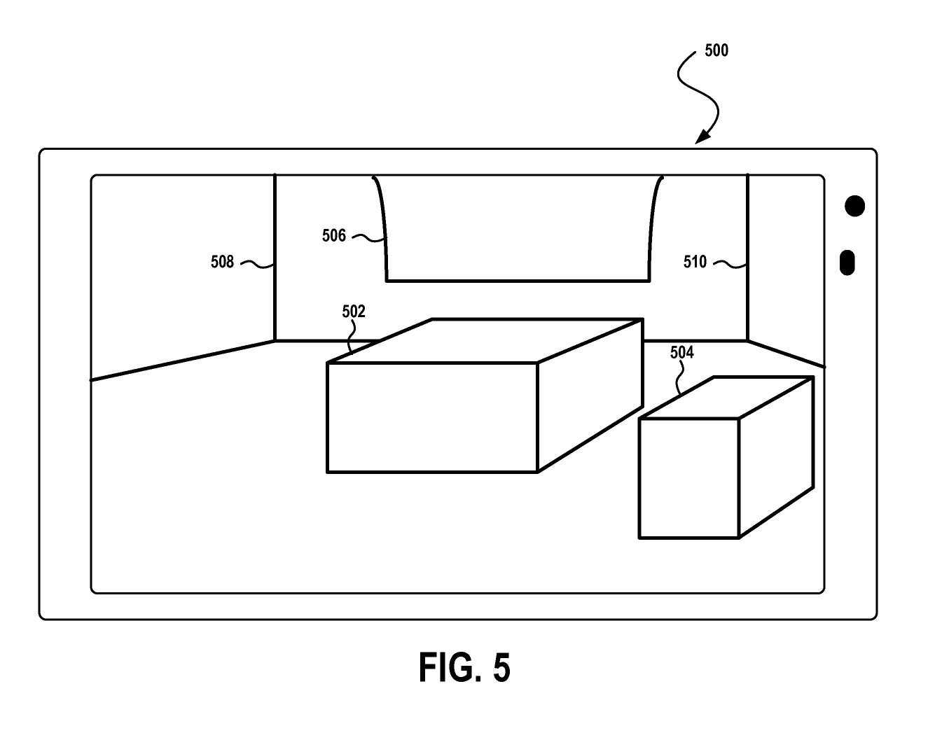

FIG. 5 is a conceptual illustration of an example computing device displaying an example map. As indicated within the method 400, a computing device may be configured to capture information from sensors to generate a map including a sparse mapping of the environment. In particular, the computing device 500 shown in FIG. 5 displays a map that includes sparse mapping based on distinct visual features of the environment as captured within information provided by sensors. The sparse mapping displayed by the computing device 500 serves as example for illustration purposes and may include more or less features of the environment in other examples.

As shown in FIG. 5, the computing device is displaying a map that includes example sparse mapping data, which may encompass visual features corresponding to potential objects 502-506 and corners 508-510. Within the example, the sparse mapping provides data points that may correspond to distinct visual features in the environment, such as the corners 508-510 of the wall. In other examples, the computing device may display a generated map that includes more or less sparse mapping data referring to a high level description of an environment. For example, the computing device 500 may include data points corresponding to more visual features in the environment.

In order to generate a map that includes the sparse mapping shown, the computing device 500 may receive outputs from device sensors. The outputs may capture information corresponding to the environment, which may be captured by the sensors when the device is at different positions and/or orientations. For example, as the sensors capture map data while the device changes positions, the sensors may track certain features of the environment, such as corners and/or borders of objects. These certain features, also known as visual features, may serve as tracking points that the computing device and/or sensors may utilize while gathering map data.

In particular, since the visual features may be distinct elements in the environment, the sensors may require less power and/or time to capture information corresponding to the features. In other words, the sensors may initially capture information corresponding to distinct features in the environment in order to generate a basic map (e.g., sparse mapping) of the environment that may provide basic information. The computing device may generate a high level map of the environment displaying basic information dependent on the visual features, for example. The visual feature within sparse mapping may indicate positioning generally of large objects and may provide as an initial top layer of information for generating a more detailed map, as described herein.

Likewise, the sparse mapping displayed by the computing device 500 may serve as an initial map for the user, computing device, and/or sensors to utilize. For example, the computing device 500 may analyze the information captured within the sparse mapping, nearby visual features in the environment, and/or device motion information from the IMU unit to determine the location of the device. The computing device may be configured to determine the pose of the device relative to visual features in the environment and/or using information captured by the IMU unit or other sensors.

As shown in FIG. 5, the sensors associated with the computing device may track corners of objects, bookshelves, walls, and/or other distinct features in the environment as the computing device changes orientation relative to the environment. The computing device may receive data indicative of the visual features from the sensors and may generate a sparse mapping based on the received data.

In addition, a computing device may generate a sparse mapping to provide boundaries and outlines of the environment. The visual features may serve as a base to build upon for the sparse mapping. For example, the computing device may add additional details to the sparse mapping after establishing the positioning, orientation, and/or other factors related to the visual features within the environment.

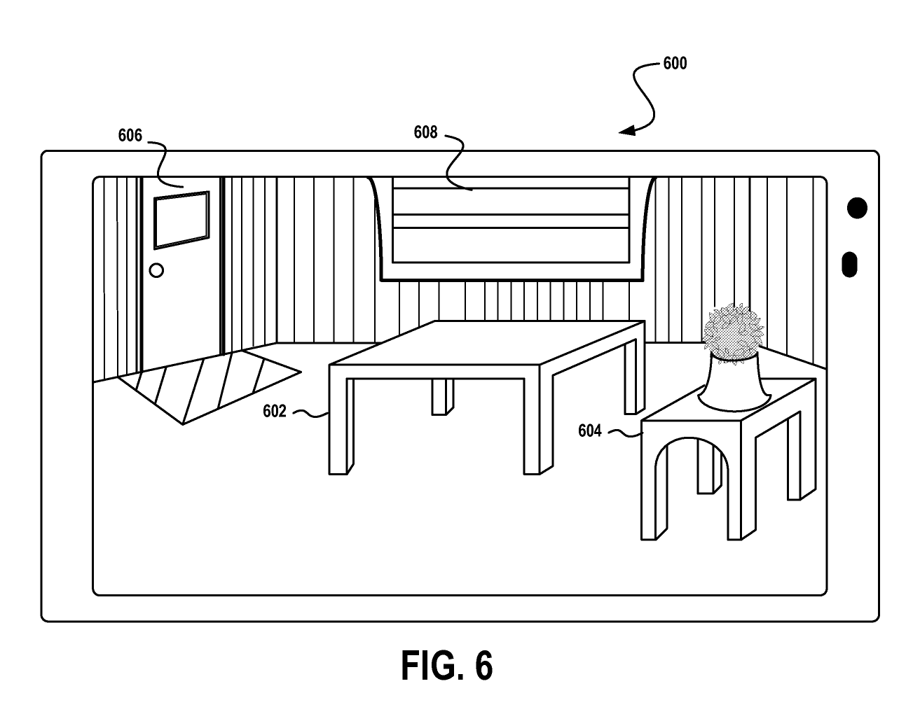

FIG. 6 illustrates another example map on a computing device, in accordance with an example implementation. As displayed by the computing device 600 in FIG. 6, the example map includes sparse mapping data as well as dense mapping information. Similar to the sparse mapping shown in FIG. 5, the map shown by computing device 600 includes the visual features, such as the corners of walls and/or borders of objects, but also includes additional details as provided by the dense mapping information captured within outputs received from sensors. Further, the environment represented by the generated map shown by the device in FIG. 6 is the same environment as the environment as the generated map shown by the device in FIG. 5. However, in other examples, generated maps may correspond to different environments and/or may include more or less elements of the environment, for example.

As provided by the map shown by the example device, a map including dense mapping information may include additional information. The dense mapping information captured by sensors may include any number of data points based on objects within the environment. For illustration purposes, the map displayed by the computing device 600 includes dense mapping information that includes a large number of data points that correspond closely to the actual boundaries and positioning of objects in the environment. However, within other examples, a computing device may generate a map that includes less dense mapping information. For example, the map may display data points corresponding to additional objects in addition to the visual features shown within a sparse mapping of the environment.

In particular, the computing device 600 displays a map that includes information corresponding to a room within a building. To further illustrate, the example map displays data points corresponding to a table 602, a small table 604, a door 606, and the bookshelf 608. The map includes a large number of data points that reflect the positioning and structure of the elements. For example, the generated map shown on computing device 600 includes data points that display the legs of the tables 602-604. This differs from the map based sparse mapping shown in FIG. 5, that displays the tables as 3D blocks rather than displaying details. Similarly, the generated map shown in FIG. 6 also includes dense mapping information corresponding to the book shelf 608.

The computing device 600 may be configured to capture additional dense mapping information that may correspond to more objects within the environment. Likewise, the dense mapping information may further provide depth and texture to objects within the environment. The computing device 600 may capture the dense mapping information to configure into the generated map illustrated within FIG. 6 using various techniques and/or sensors, such as using a depth camera along with structured light.

In addition, the example generated map displays data points corresponding to a door 606, which is not shown within the sparse mapping of FIG. 5. The dense mapping information captured by sensors may capture additional details to an environment for a computing device to utilize within a generated map. The data points indicative to the door 606 serve as an illustration of a possible detail that dense mapping information may capture. Other examples may exist as well.

In some implementations, the map may include additional information and/or less information. For example, the map displayed by the computing device 600 may not include information corresponding to the bookshelf 608, since the bookshelf 608 may not be tracked within sensor data by a computing device. The computing device may configure generated map to include additional or less sparse mapping data and/or the dense mapping information to include other data as well.

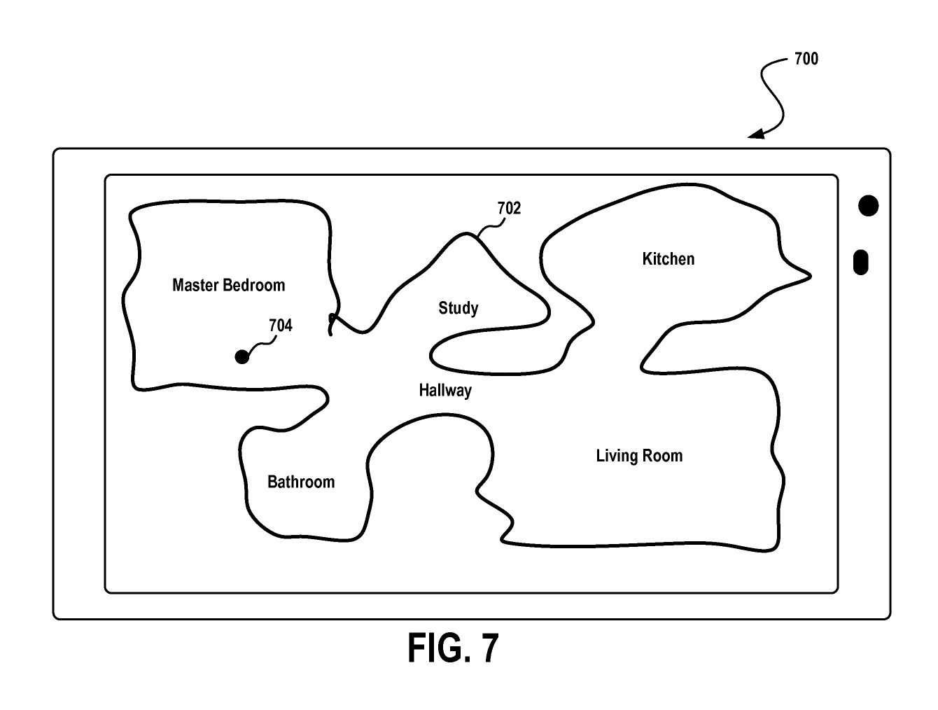

FIG. 7 illustrates an overview of an example map, in accordance with an example implementation. In the example shown in FIG. 7, a computing device 700 is displaying a developed map 702 that shows a birds-eye view of an environment (e.g., a house).

As shown within the example FIG. 7, the generated map may exist as some format of semantic mapping, which may include providing identifications for various regions of the environment (e.g., rooms of a building).

Specifically, the computing device 700 displays a map that approximately outlines the boundaries of the rooms in the house. In addition, the generated map 702 displayed by computing device 700 includes labels for the various rooms. A computing device may be configured to identify rooms based on object detection within the rooms. For example, the computing device may identify a bed within a room using sensor information and identify the room as a bedroom within the generated map. Further, the computing device may enable a user to further identify objects and/or space as shown in a generated map. This may enable a user to customize a map generated based on the user's house, for example.

Furthermore, the map 702 also includes a dot 704 that indicates the location of the computing device 700 according to the map 702. The map 702 may use other means to provide the location of the computing device 700. The location may be based on information captured by sensors, such as the IMU unit, and/or object detection based on the generated map, for example.

In an example implementation, a user may view the overview map 702 as provided by the computing device 700 to determine a location of the computing device 700 as indicated by the location dot 704. For example, the computing device 700 may have been turned off and may be configured to determine a location after being powered back on. The computing device 700 may utilize information provided by the map 702 to determine its location. In particular, the computing device 700 may also utilize information captured by sensors, such as motion information, to determine a pose and a location of the device and may use the generated map 702 to determine a location of the device and/or directions that user may need to travel. The computing device may determine various routes based on using the information provided by the map 702.

Furthermore, a computing device may store relationships of regions and/or places in 3D space and/or in the terms of topological information. Topological information may relate to shapes of objects and spaces within the environment, for example. The topological information may also include information relating to properties of space, such as connectedness, continuity, and boundary. For example, the computing device may use topological information to determine spatial relationships between certain areas in the environment (e.g., bedroom connected to hallway connect to bathroom, etc.), which may be useful when the computing device may not know actual distances.

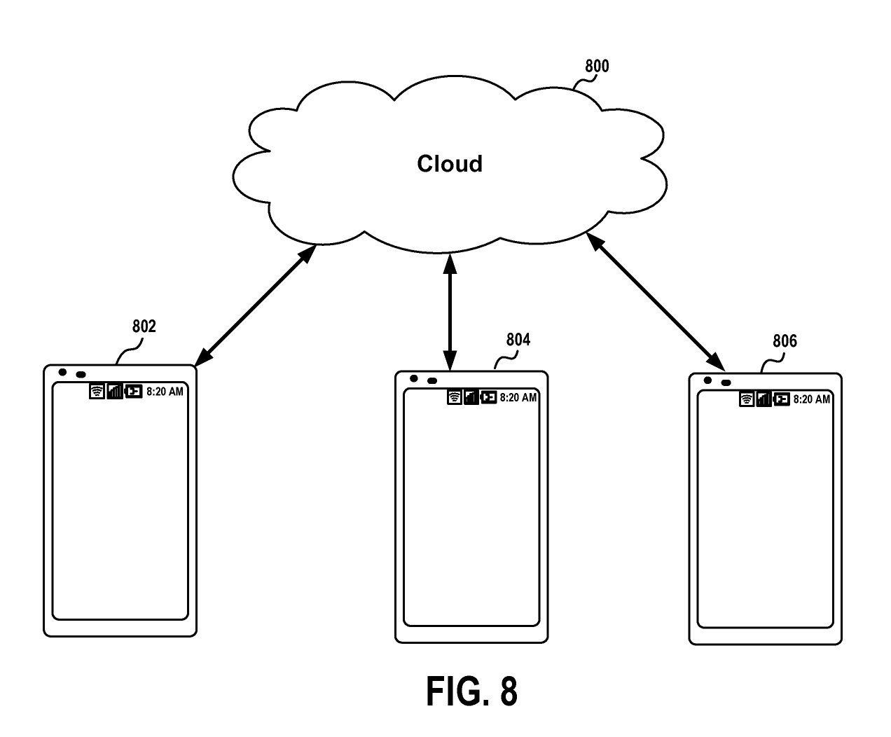

FIG. 8 is a conceptual illustration of an example cloud in communication with example computing devices. In particular, the example illustrated in FIG. 8 includes a cloud 800 communicating with multiple computing devices 802-806. Although the example illustrated in FIG. 8 shows a cloud 800 communicating with multiple computing devices, other entities (e.g., a physical server) may also perform the functions of the cloud 800. The cloud 800 described herein is for illustration purposes, but is not intended to be limiting.

As illustrated in FIG. 8, a cloud 800 may be configured to send and receive information with computing devices. The cloud 800 may be created and maintained by a server or network of servers, for example. The cloud 800 may exist across multiple computing devices and may utilize various formats of memory. In addition, the cloud 800 may be configured with security restrictions, which may limit access to computing devices based on various factors. For example, a computing device may need to provide a password or some other form of identification information to the cloud 800 in order to establish a communication link. In some instances, the cloud 800 may be configured to provide information, but may not be configured to receive information. Likewise, the cloud 800 may be configured to receive information without having the permission and/or components to transmit information to devices.

In addition to the cloud 800, FIG. 8 also shows computing device 802-806, which are configured as mobile computing devices. In other examples, the computing devices 802-806 may include any type of computing device capable of sending and/or receiving information, including the example computing devices illustrated in FIGS. 1-2 and FIGS. 3A-3B. In particular, the computing devices 802-806 may communicate with other devices and/or the cloud through various communication means, such as electromagnetic wireless telecommunications (e.g., radio), for example.

In an example implementation, the respective computing devices 802-806 may capture information about the environment using sensors and generate mapping data based on the captured information. As described previously, a computing device may generate map data through receiving information from sensors when the computing device is in various positions and/or orientations. The computing device may build up the map data, which may include sparse mapping information corresponding to visual features in the environment and dense mapping information that provides details in addition to the visual features to the objects in the environment. As the computing device generates map data, the computing device may send the data to the cloud 800 for storage, for example. The computing device may transmit information relating to the environment, including, but not limited to the visual features of spaces in the environment, dense mapping information, and information regarding the computing device's pose relative to the environment when capturing the various information. For example, the computing device may provide its global coordinates in addition to the map data to the cloud in order to enable the cloud to have a frame of reference (e.g., knowledge of the computing device's location).

The cloud 800 may be configured to accept map data and other information from multiple devices, as shown in FIG. 8. In one aspect, the cloud 800 may be configured to act as individual storage units for each of the devices that communicate with the cloud 800. In particular, the cloud 800 may receive and store map data for each respective computing device without blending the various map data received. In such a case, the respective computing devices 802-806 may access map data and/or other information stored in the cloud 800 for various reasons (e.g., computing device accidently erased the data located on the device's memory).

In another aspect, the cloud 800 may be configured to aggregate the map data received from multiple devices in order to generate a map based on the information gathered from the sensors of the multiple devices. In some instances, the cloud 800 may generate a map that includes more information than the maps located on the individual computing devices since the cloud 800 utilized the information provided by multiple devices. The cloud 800 may generate a map that includes information corresponding to any number of environments based on the environments captured by respective device sensors. In addition, the cloud may accumulate map data and/or other information from multiple devices in real-time or may receive the information through the application of a timed process.

Furthermore, the cloud may store the map data as connected to specific devices or may group the map data without linking the data specifically to respective devices. Therefore, the information gathered from devices may aggregate to generate a map computation without connecting the map as collected by particular devices.

In the case that the cloud may store information and map data to devices, the cloud may serve as memory that the device may access the map and information without other devices having access. In another example, the cloud may be configured to provide access to any information gathered from devices to all other devices. In some instances, the cloud may require some identification process to clear devices to access the aggregated information and/or map.

The cloud may require passwords or may store and remember identification codes linked to the devices.

Within examples, the cloud 800 may receive information and/or map data from multiple devices, including a large number of devices operating on various device platforms, for example. The cloud may aggregate the information and generate a large map that organizes the various maps received from devices in a logical manner. The cloud 800 may receive observations of environments from multiple devices to alter its generated collaborative map.

In one such example, the cloud 800 may not immediately utilize new observations from devices, but may require repetitive observations containing the same information to cause the cloud 800 to utilize the observations within its generated map computation. For example, the cloud 800 may receive information that furniture had been rearranged within a building location. The cloud 800 may already have map data corresponding to the building and may determine that the newly received observations from devices conflict with the existing map data. In one case, the cloud 800 may update the map data to reflect to newly received observations showing the furniture located within new spots in the building. However, in some instances, the cloud 800 may be configured to receive multiple observations reflecting the change in the positioning of the furniture prior to modifying its map data to reflect the furniture in the new positions as observed by the devices.

In one example implementation, the cloud 800 may provide updates of the stored map data in the cloud to devices on predefined basis. For example, the cloud 800 may update a device's map every time the device receives a request to utilize the map data. Likewise, the cloud may update a device's map continuously in real-time. In other instances, the cloud may provide updates to a device's map periodically or on some other predefined schedule. Other updating processes may exist as well.

Further, the cloud 800 may perform some form of semantic mapping, which may include identifying spaces. The cloud 800 and/or a computing device may identify spaces and/or regions of an environment based on 3D geometry and/or on potential use. For example, a computing device may determine that a room that includes a toilet may be identified as a bathroom. The computing device and/or cloud 800 may store identification information with the rooms within the map data (e.g., labeling the bathroom). A computing device may provide the map for determining locations of particular rooms relative to the device (e.g., where is the location of a bathroom).

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense.

1. A method performed by a device having a plurality of sensors, the method comprising:
receiving one or more outputs of the plurality of sensors at a first position of the device in an environment, wherein the one or more outputs comprise a first set of data corresponding to one or more visual features of the environment associated with the first position;
generating, based on correspondence in the one or more outputs of the plurality of sensors, a map of the environment comprising sparse mapping data indicative of the first set of data;
receiving one or more additional outputs of the plurality of sensors at a second position of the device in the environment, wherein the one or more additional outputs comprise a second set of data corresponding to one or more visual features of the environment associated with the second position;
modifying the map of the environment to further comprise sparse mapping data indicative of the second set of data;
receiving dense mapping information via one or more of the plurality of sensors, wherein the dense mapping information comprises data corresponding to objects in the environment in a manner representative of a relative structure of the objects in the environment; and
modifying the map of the environment to comprise the dense mapping information.

2. The method of claim 1, further comprising:
receiving additional data from a server, wherein the additional data comprises sparse mapping data and dense mapping information corresponding to a plurality of environments aggregated from a plurality of devices; and
based on the additional data, modifying the map of the environment to comprise the sparse mapping data and dense mapping information corresponding to the environment.

3. The method of claim 1, wherein the plurality of sensors include one or more of a gyroscope, accelerometer, camera, barometer, magnetometer, global positioning system (GPS), Wi-Fi sensor, near-field communication (NFC) sensor, and Bluetooth sensor.

4. The method of claim 1, further comprising:
determining an identification of a region in the environment based on one or more objects in the dense mapping information; and
providing, within the map of the environment, the identification of the region in the environment.

5. The method of claim 1, further comprising:
determining a relationship between the first position in the environment and the second position in the environment, wherein the relationship includes topological information corresponding to the environment; and
providing, within the sparse mapping, information associated with the relationship.

6. The method of claim 1, wherein receiving dense mapping information via one or more of the plurality of sensors comprises:
receiving the dense mapping information via a camera system, wherein the camera system is configured to capture depth images of the environment.

7. The method of claim 6, further comprising generating a three-dimensional geometry of at least a portion of the environment based on the depth images.

8. The method of claim 1, further comprising:
identifying, via one or more of the plurality of sensors, data in the sparse mapping corresponding to one or more moving objects in the environment; and
removing the data in the sparse mapping corresponding to the one or more moving objects.

9. The method of claim 1, further comprising:
determining, via one or more sensors of the plurality of sensors, a pose of the device, wherein the pose of the device comprises an orientation of the device relative to the one or more visual features in the environment and a direction of gravity;
identifying a geographic location of the one or more visual features in the sparse mapping; and
based at least in part on the pose of the device and the geographic location of the one or more visual features in the sparse mapping, determining a relative location of the device in the environment.

10. The method of claim 1, wherein receiving dense mapping information via one or more of the plurality of sensors comprises:
capturing the dense mapping information via at least one camera and a structured light sensor from one or more different angles relative to the environment and the device.

11. The method of claim 1, wherein modifying the map of the environment to further comprise sparse mapping data indicative of the second set of data further comprises:
determining a correspondence between one or more visual features of the environment associated with the second position to one or more visual features of the environment associated with the first position; and
based on the correspondence being above a threshold, modifying the map of the environment comprising the sparse mapping data to further comprise the second set of data.

12. A system comprising:
a plurality of sensors;
at least one processor; and
a memory having stored thereon instructions that, upon execution by the at least one processor, cause the system to perform functions comprising:
receiving one or more outputs of the plurality of sensors at a first position of the device in an environment, wherein the one or more outputs comprise a first set of data corresponding to one or more visual features of the environment associated with the first position;
generating, based on correspondence in the one or more outputs of the plurality of sensors, a map of the environment comprising sparse mapping data indicative of the first set of data;
receiving one or more additional outputs of the plurality of sensors at a second position of the device in the environment, wherein the one or more additional outputs comprise a second set of data corresponding to one or more visual features of the environment associated with the second position;
modifying the map of the environment to further comprise sparse mapping data indicative of the second set of data;
receiving dense mapping information via one or more of the plurality of sensors, wherein the dense mapping information comprises data corresponding to objects in the environment in a manner representative of a relative structure of the objects in the environment; and
modifying the map of the environment to comprise the dense mapping information.

13. The system of claim 12, wherein the functions further comprise:
receiving additional data from a server, wherein the additional data comprises sparse mapping data and dense mapping information corresponding to a plurality of environments aggregated from a plurality of devices; and
based on the additional data, modifying the map of the environment to comprise the sparse mapping data and dense mapping information corresponding to the environment.

14. The system of claim 12, wherein the functions further comprise:
determining, via one or more sensors of the plurality of sensors, a pose of the device, wherein the pose of the device comprises an orientation of the device relative to the one or more visual features in the environment and a direction of gravity;
identifying a geographic location of the one or more visual features in the sparse mapping; and
based at least in part on the pose of the device and the geographic location of the one or more visual features in the map of the environment, determining a relative location of the device in the environment.

15. A non-transitory computer readable medium having stored thereon instructions that, upon execution by a computing device, cause the computing device to perform functions comprising:
receiving one or more outputs of the plurality of sensors at a first position of the computing device in an environment, wherein the one or more outputs comprise a first set of data corresponding to one or more visual features of the environment associated with the first position;
generating, based on correspondence in the one or more outputs of the plurality of sensors, a map of the environment comprising sparse mapping data indicative of the first set of data;
receiving one or more additional outputs of the plurality of sensors at a second position of the computing device in the environment, wherein the one or more additional outputs comprise a second set of data corresponding to one or more visual features of the environment associated with the second position;
modifying the map of the environment to further comprise sparse mapping data indicative of the second set of data;
receiving dense mapping information via one or more of the plurality of sensors, wherein the dense mapping information comprises data corresponding to objects in the environment in a manner representative of relative structure of the objects in the environment; and
modifying the map of the environment to comprise the dense mapping information.

16. The non-transitory computer readable medium of claim 15, wherein the function of receiving dense mapping information via one or more of the plurality of sensors comprises:
receiving the dense mapping information via a camera system, wherein the camera system is configured to capture depth images of the environment.

17. The non-transitory computer readable medium of claim 15, wherein the functions further comprise: continuously updating the map of the environment based on additional outputs received from the plurality of sensors.

18. The non-transitory computer readable medium of claim 15, wherein the map of the environment further includes semantic mapping information, wherein the semantic mapping information identifies one or more regions in the map of the environment based on three dimensional geometry and one or more objects in the one or more regions in the environment.

19. The non-transitory computer readable medium of claim 15, wherein the function of receiving dense mapping information via one or more of the plurality of sensors comprises:
receiving data corresponding to one or more objects in the environment via one or more depth sensors; and
configuring the data corresponding to one or more objects with images captured by a camera to generate dense mapping information.

20. The non-transitory computer readable medium of claim 15, wherein the functions further comprise:
receiving data indicative of one or more Wi-Fi access points; and
modifying the map of the environment to further include the data indicative of the one or more Wi-Fi access points.
